(19) United States
(12) Patent Application Publication
(10) Pub. No.: US 2007/0029144 A1
(43) Pub. Date: Feb. 8, 2007

(54) Disc brake operating system

(75) Inventor: Kazuhiro Sekiguchi, Tokyo (JP)

Correspondence Address: MORGAN LEWIS & BOCKIUS LLP, 1111 PENNSYLVANIA AVENUE NW, WASHINGTON, DC, 20004, US

(73) Assignee: Akebono Brake Industry Co., Ltd.

(21) Appl. No.: 11/497,261

(22) Filed: Aug. 2, 2006

(30) Foreign Application Priority Data
Aug. 4, 2005 (JP) P.2005-226175
Nov. 29, 2005 (JP) P.2005-344143

(51) Int. Cl. F16D 55/08

(52) U.S. Cl. 188/72.8; 188/72.7

(57) ABSTRACT

A parking operation mechanism is provided with: an adjusting spindle of an adjuster mechanism, a cam shaft which is located orthogonally to the adjusting spindle and has a parking lever at one end thereof; and a thrust transmitting assembly which is arranged between the cam shaft and the adjusting spindle, and has rolling rollers which generate thrust. A rolling curve surface provided on the cam shaft is formed on a recess groove extending to the shaft end portion. The rolling rollers are housed in the rolling curves surfaces. Their axial movement is regulated by a regulating member.

The present application claims foreign priority based on Japanese Patent Application Nos. P.2005-226175 filed on Aug. 4, 2005, and P.2005-344143 filed on Nov. 29, 2005, the contents of which are incorporated herein by reference.

### BACKGROUND OF THE INVENTION

1. Field of the Invention

The present invention relates to a disc brake operating system which includes parking operation mechanism on one end side of a caliper that supports slidably a piston including an adjuster mechanism.

2. Related Art

Conventionally, as a parking operation mechanism of a disc brake operating system, push rod type parking brake structure has been known (refer to, for example, JP-A-09-025971), in which a parking lever is provided at one of a cam shaft arranged perpendicularly to an adjusting spindle in an adjuster mechanism, and the cam shaft is rotated by drive of this parking lever thereby to give axial thrust to the adjusting spindle.

FIG. 17 is a partially cross sectional view of a parking operation mechanism provided with a push rod in such the conventional disc brake operating system. When a parking lever 205 is driven and rotated, a cam shaft 201 provided at one end of the parking lever 205 rotates, a push rod 202 pushes out a press member 203 in the left direction and operates a not-shown brake piston, and simultaneously its reaction force operates a caliper 207 in the right direction, whereby a pair of brake pads holds a brake disc between them with a high power assist ratio to perform a braking operation.

In such the conventional parking operation mechanism using the push rod 202, the push rod 202 tilts and transmits the axial thrust to the press member 203 precisely even if the cam shaft rotates in any position. However, a cam groove 201a formed in the peripheral surface of the cam shaft 201, in which the push rod 202 is housed, must be a groove which permits the tilt of the push rod 202. In case that the cam groove 201a is formed by cutting, there is a problem that mass productivity is poor and cost is high. Therefore, it is also thought that formation of this cam groove 201a is performed by forging. However, in this case, there is a difficult point that a portion around a hole deforms in a bulge state at the time of forging thereby to require cutting in the last step.

In addition, as shown in FIG. 17, with the cam groove 201a formed in the cam shaft 201, one end of the push rod 202 is engaged, and the other end of the push rod 202 comes into contact with a recess groove 203a provided at the end of the press member 203. To a protruding part 201b protruding from a cam shaft hole 204 of the cam shaft 201, the parking lever 205 connected to a brake operating cable is fixed. The periphery on the leading end side of the protruding part 201b of the cam shaft 201 is surrounded by a return spring 206. One end of the return spring 206 is locked to the parking lever 205, and the other thereof is engaged with a stop pin 208 provided upright for the caliper 207. Further, for the stop pin 208, a conical press spring 209 is provided, and energizes the cam shaft 201 in the direction of a bottom of the cam shaft hole 204. Therefore, even if the cam shaft 201 attempts to come off from the cam shaft hole 204, it is pressed by the press spring 209, whereby coming-off of the camshaft 201 is prevented.

In case that the parking operation mechanism is used as a parking brake during stopping of a vehicle, the brake operating cable is operated, whereby the parking lever 205 rotates the cam shaft 201, the push rod 202 presses the press member 203 thereby to drive a not-shown piston, and a frictional pad is pressed on a rotor. In result, braking power as parking braking force can be applied to the vehicle. When the operation of the brake operating cable is released, the cam shaft 201 is returned to the initial position by the return spring 206 and the braking action is released.

In the conventional rotation-linear converting part described in JP-A-09-025971, the conical press spring 209 for preventing coming-off of the cam shaft 201 is required, and the conical press spring 209 must be incorporated in the narrow space between the cam shaft 201 and the stop pin 208, which causes a problem of requiring much labor and a long time.

The invention, in view of these problems, has been made. The object of the present invention is to provide a disc brake operating system provided with parking operation mechanism in which a cam groove formed in a cam shaft is so constructed that mass productivity is good and cost is reduced, power transmission loss is suppressed even if the axial thrust increases, and braking force of high power assist ratio can be stably given.

In addition, another object of the present invention is to provide a disc brake operating system provided with parking operation mechanism which can prevent, without requiring a special part for preventing coming-off of a cam shaft, its coming-off in the usual parts assembling process.

### SUMMARY OF THE INVENTION

In accordance with one or more embodiments of the present invention, as a first aspect of the invention, a disc brake operating system is provided with a parking operation mechanism on one end side of a caliper that supports slidably a piston including an adjuster mechanism, wherein the operation mechanism includes an adjusting spindle of the adjuster mechanism, a camshaft which is located orthogonally to the adjusting spindle and has a parking lever at one end thereof, and a thrust transmitting assembly which is arranged between the cam shaft and the adjusting spindle, and gives axial thrust to the adjusting spindle by rotational movement of the cam shaft; the thrust transmitting assembly includes a rolling roller which rolls between the cam shaft and the adjusting spindle while turning on its axis, and rolling curved surfaces provided for the cam shaft which comes into contact with the rolling roller and for the adjusting spindle; the rolling curved surface provided for the cam shaft is formed on a recess groove extending to the side opposite to the parking lever; and the rolling roller is housed in the rolling curved surface and its axial movement is regulated by a regulating member.

Further, as a second aspect of the invention, a second thrust transmitting assembly may be arranged between the opposite rotor side of the cam shaft and the caliper.

Further, as a third aspect of the invention, the regulating member may be a regulating block member fixed into the recess groove from the end side of the cam shaft.

Further, as a fourth aspect of the invention, the regulating member may be a C-shaped regulating block member fixed into the recess groove from the end side of the cam shaft.

Further, as a fifth aspect of the invention, the regulating member may be a ring member inserted into a ring groove formed in the cylindrical outer surface of the cam shaft.

Further, as a sixth aspect of the invention, the regulating member may be a sleeve fixed to a diameter-reduced step portion formed at an end of the cam shaft, which is located on the opposite side to the parking lever.

Further, as a seventh aspect of the invention, a cylindrical hole facing in an axial direction of the adjusting spindle, and an insertion hole facing in an orthogonal direction to the cylindrical hole may be formed at the opposite rotor-side end of the caliper; and a guide member which slides and supports the cam shaft inserted from the insertion hole may be fixed into the cylindrical hole.

Further, as an eighth aspect of the invention, the cam shaft may be slid and supported by a pair of notch grooves formed in a cylindrical portion of the guide member.

Further, as a ninth aspect of the invention, a dust boot may be arranged between the insertion hole formed in the opposite rotor-side end of the caliper and the cam shaft; and the dust boot may be attached by a parking lever guide for suppressing a tilt of the parking lever which is arranged on one side of the cam shaft.

Further, as a tenth aspect of the invention, the caliper may include a housing installed consecutively at its opposite rotor-side end; and the adjusting spindle, the thrust transmitting assembly and the cam shaft are integrally assembled in the housing.

In addition, in accordance with one or more embodiments of the present invention, as a eleventh aspect of the invention, a disc brake operating system is provided with a parking operation mechanism on one end side of a caliper that supports slidably a piston including an adjuster mechanism. The operation mechanism includes an adjusting spindle of the adjuster mechanism, a cam shaft which is orthogonal to the adjusting spindle and has a parking lever at one end thereof, and a rotation-linear converting part which is arranged between the cam shaft and the adjusting spindle, and gives axial thrust to the adjusting spindle by rotation of the cam shaft. The rotation-linear converting part includes a first roller plug which comes into contact with and engages with the adjusting spindle, a first rolling roller which rolls between the cam shaft and the first roller plug while turning on its axis, and is held in a cam groove of the cam shaft, a second roller plug which comes into contact with and engages with a caliper housing, and a second rolling roller which rolls between the cam shaft and the second roller plug while turning on its axis, and is held in a cam groove of the cam shaft. By spring power of a spring which acts on a holder engaging with the adjusting spindle, the adjusting spindle presses the first roller plug through the first rolling roller to the camshaft side. The holder regulates the axial positions of both end portions of the first rolling roller on its end inner surfaces.

Further, as a twelfth aspect of the invention, the holder may be formed in section nearly in the shape of a hat, and includes a flange portion which holds one end of the spring at one end thereof, and a locking portion which is engaged with the adjusting spindle at the other end thereof.

Further, as a thirteenth aspect of the invention, the first and second rolling rollers may be housed partially in the cam grooves formed in the cam shaft, and the lower end surfaces of the both rolling rollers may be regulated in their axial positions by a roller support ring provided for the cam shaft.

In the disc brake operating system including parking operation mechanism according to the first aspect of the invention, not only braking force of a high power assist ratio can be stably given by combination of the rolling roller and the rolling curve surface, but also the power transmission loss can be suppressed under even the great axial thrust because there is provided the rolling roller which rolls between the cam shaft and the adjusting spindle while turning on its axis. Further, since the rolling curved surface provided for the camshaft is formed on the recess groove extending to the opposite side to the parking lever, it can be formed by cold forging (by a header), so that the cost can be reduced and productivity improves.

In the disc brake operating system including parking operation mechanism according to the second aspect of the invention, since the second thrust transmitting assembly is arranged between the rolling curved surface provided on the opposite rotor side of the cam shaft and the rolling curved surface provided on the caliper side thereof, longer piston stroke can be secured.

In the disc brake operating system including parking operation mechanism according to the third aspect of the invention, since the regulating block member is fixed into the recess groove extending to the end of the cam shaft, the movement in the axial direction of the rolling roller can be surely restricted.

In the disc brake operating system including parking operation mechanism according to the fourth aspect of the invention, the movements in the axial direction of their rolling rollers in the two thrust transmitting assemblies can be simultaneously restricted by one C-shaped regulating block member.

In the disc brake operating system including parking operation mechanism according to the fifth aspect of the invention, since the regulating member is the ring member inserted into the ring groove of the cam shaft, the constitution of parts is simple, and the assembly is easy without effort.

In the disc brake operating system including parking operation mechanism according to the sixth aspect of the invention, since the regulating member is the sleeve, the rolling curved surface of the cam shaft and the diameter-reduced step portion can be formed by cold forging. Further, since the regulating member is fixed to the diameter-reduced step portion which is larger in area, the movement in the axial direction of the rolling roller can be surely restricted.

In the disc brake operating system including parking operation mechanism according to the seventh aspect of the invention, since the guide member is provided separately from the caliper, complicated working is not necessary for build of the caliper.

In the disc brake operating system including parking operation mechanism according to the eighth aspect of the invention, since the groove width of the notch groove in the guide member can be determined according to the shaft diameter of the cam shaft, the invention can be applied to various cam shafts which are different in shaft diameter. Further, since the position of the notch groove in the guide member can be free set, the axes of the adjusting spindle and the cam shaft need not be on the same level, and design freedom is large.

In the disc brake operating system including parking operation mechanism according to the ninth aspect of the invention, the dust boot is attached by the parking lever guide for suppressing the tilt of the parking lever. Therefore, the number of parts can be reduced.

In the disc brake operating system including parking operation mechanism according to the tenth aspect of the invention, the adjusting spindle, the thrust transmitting assembly and the cam shaft can be previously assembled in the housing. By removing the housing from the caliper, each part can be disassembled easily.

In addition, in the disc brake operating system including parking operation mechanism according to the eleventh aspect, by the end inner surfaces of the holder as a spring receiving part used when the adjusting spindle is pressed through the first roller plug and the first rolling roller to the cam shaft side, the axial positions of the both end portions of the first rolling roller are restricted. Therefore, it is not necessary to prepare a special coming-off preventing part, but the coming-off of the cam shaft which holds the first rolling roller in the cam groove is prevented. Accordingly, it is not necessary to prepare the special part for preventing the coming-off of the camshaft, but the coming-off of the cam shaft can be prevented in the usual parts assembling process.

In the disc brake operating system including parking operation mechanism according to the twelfth aspect, since the holder is formed in section nearly in the shape of a hat, it can fulfill its engaging function with the adjusting spindle, and its holding function of the spring receiving part and the first rolling roller.

In the disc brake operating system including parking operation mechanism according to the thirteenth aspect, by the roller support ring which regulates the axial positions of the lower end surfaces of the first and second rolling rollers, it is possible to prevent the first rolling roller from coming-off of the camshaft and the cam shaft from coming-off to the parking lever side.

Other aspects and advantages of the invention will be apparent from the following description and the appended claims.

### BRIEF DESCRIPTION OF THE DRAWINGS

FIG. 1 is a sectional view showing the whole of a main portion of a disc brake operating system including parking operation mechanism in a first exemplary embodiment of the invention.

FIG. 2 is an exploded perspective view of an adjusting spindle, a cylindrical guide and a cam shaft in the above parking operation mechanism.

FIG. 3 is a sectional view in which the adjusting spindle and the cam shaft in the parking operation mechanism are incorporated into a cylindrical guide.

FIG. 4 is a schematically sectional view in which the camshaft and the parking lever in the parking operation mechanism are incorporated.

FIG. 5(a) is a perspective view of a cam shaft assembly before assembly.

FIG. 5(b) is a perspective view of a cam shaft assembly after assembly.

FIG. 6 is an explanatory view for explaining a lever ratio in the parking operation mechanism.

FIG. 7(a) is a perspective view showing a state before incorporation of rolling rollers into a cam shaft in a second exemplary embodiment.

FIG. 7(b) is a perspective view showing a state of completion of incorporation of rolling rollers into the cam shaft.

FIG. 8(a) is a perspective view showing a state before incorporation of rolling rollers into a cam shaft in a third exemplary embodiment.

FIG. 8(b) is a perspective view showing a state of completion of incorporation of rolling rollers into the cam shaft.

FIG. 9 is a sectional view showing the whole of a main portion of a disc brake operating system including parking operation mechanism according to a fourth exemplary embodiment of the invention.

FIG. 10 is an exploded perspective of the parking operation mechanism.

FIG. 11(a) is a sectional view of a built-in rotation-linear converting part of the parking operation mechanism.

FIG. 11(b) is a sectional view taken along a line A-A in FIG. 11(a).

FIG. 12 is a perspective view of an adjusting spindle and a first roller plug.

FIG. 13 is a perspective view of the first roller plug and a second roller plug which are built in each other.

FIG. 14 is a partially broken and perspective view of the rotation-linear converting part, showing the details of a holder.

FIG. 15 is a perspective view showing a holding state of a first rolling roller by the holder.

FIG. 16 is a perspective view showing a holding state of both rolling rollers by a ring provided for a cam shaft.

FIG. 17 is a partially sectional view of parking operation mechanism in a conventional disc brake operating system.

### DETAILED DESCRIPTION OF THE EXEMPLARY EMBODIMENTS

Exemplary embodiments of the invention will be described with reference to the accompanying drawings.

### First Exemplary Embodiment

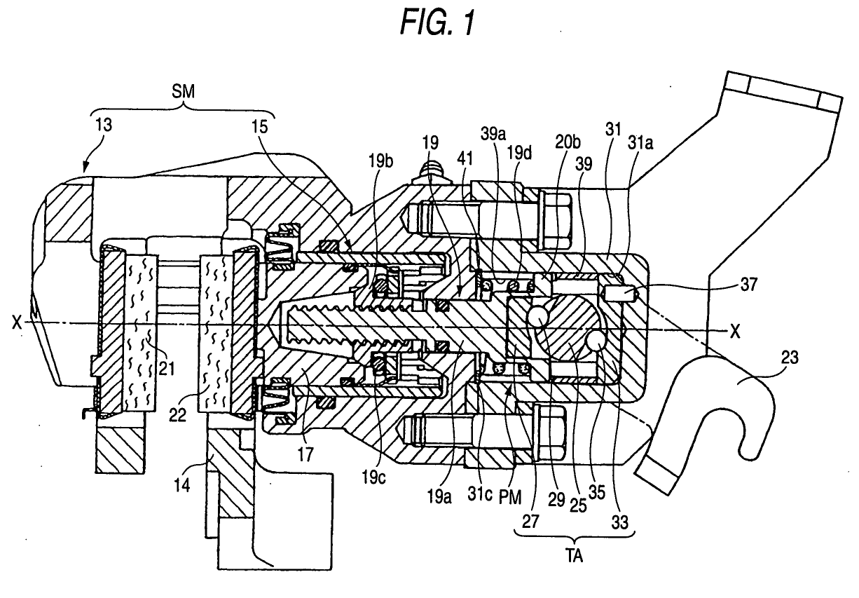

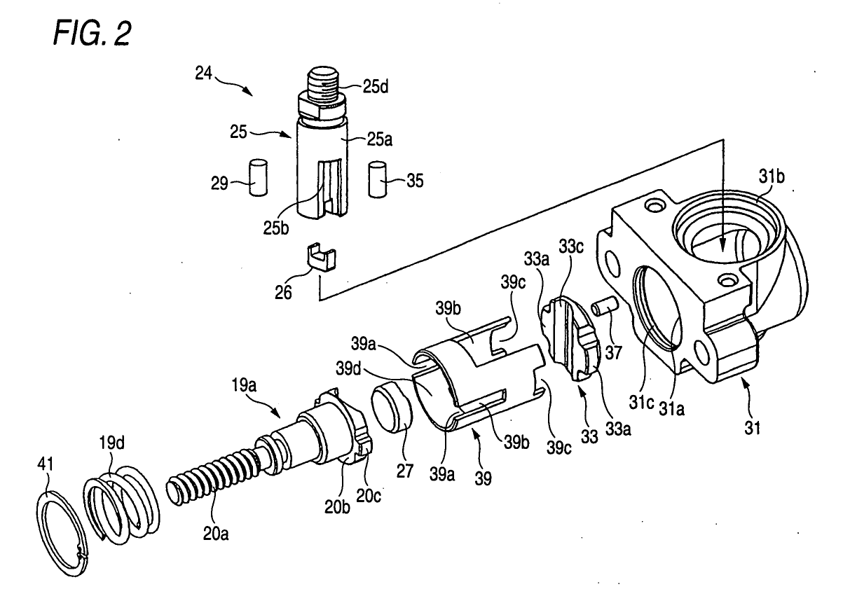

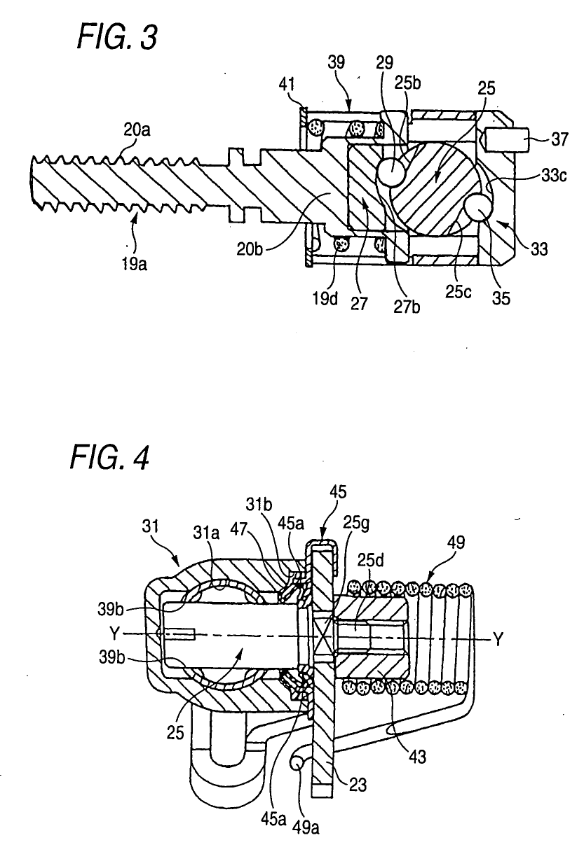

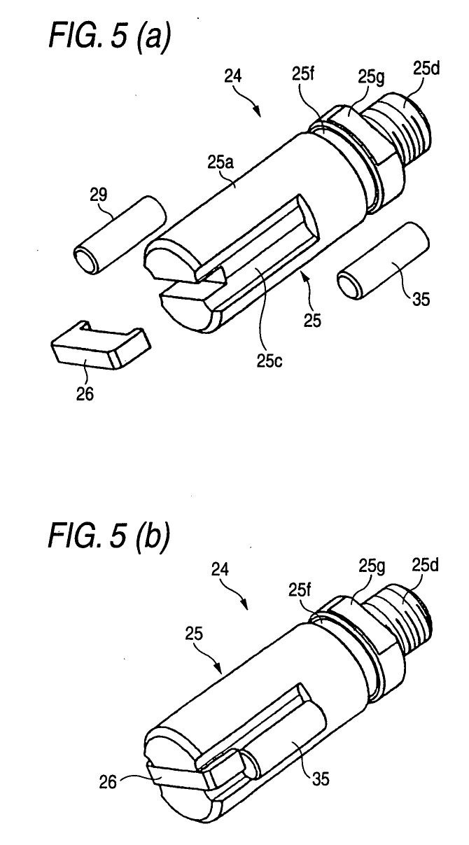

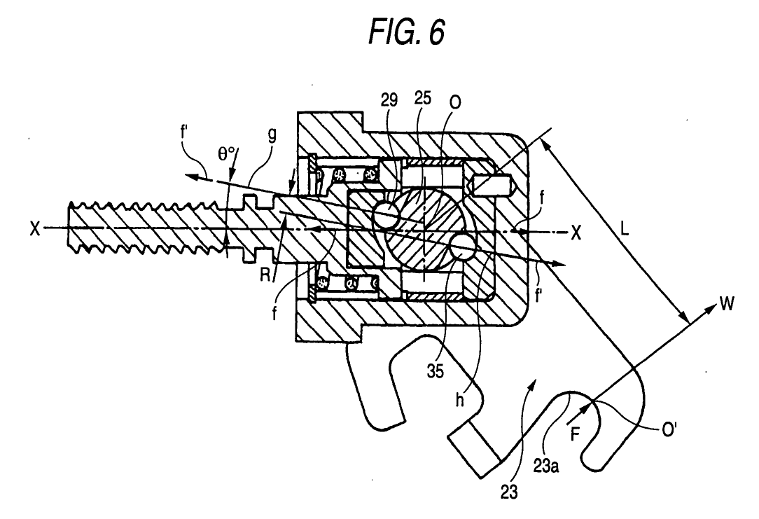

A first exemplary embodiment of the invention will be described with reference to FIG. 1. FIG. 1 is a sectional view showing the whole of a main portion of a disc brake operating system including parking operation mechanism according to the first exemplary embodiment of the invention, FIG. 2 is an exploded perspective view of an adjusting spindle, a cylindrical guide and a cam shaft in the parking operation mechanism, FIG. 3 is a sectional view in which the adjusting spindle and the cam shaft in the parking operation mechanism are incorporated into the cylindrical guide, FIG. 4 is a schematically sectional view in which the cam shaft and a cam lever in the parking operation mechanism are incorporated, FIG. 5 is a perspective view of a cam shaft assembly before and after the assembly, in which FIG. 5(a) shows a state before the assembly and FIG. 5(b) shows a state where the assembly has been completed, and FIG. 6 is an explanatory view for explaining a lever ratio in the parking operation mechanism.

As shown in FIG. 1, a disc brake operating system of the invention includes a service brake mechanism (SM) for fluid operation which consists of a caliper 13 and a piston assembly 15, and a parking operation mechanism (PM). The piston assembly 15 includes a piston 17 which receives fluid pressure at the applying time of service brake and slides in the caliper 13, and an adjuster assembly 19 for compensating abrasion of a brake pad and preventing over-adjustment. This caliper 13 is supported slidably in relation to a fixed support 14.

As the adjuster assembly 19, the known reversible screw type is used. This reversible screw type adjuster consists of an adjusting spindle 19a having a reversible screw, an adjust sleeve 19b into which this spindle 19a is screwed, a bearing 19c which supports rotational movement of the adjust sleeve 19b, and a spring 19d. When the abrasion of brake pads 21, 22 becomes more than the predetermined value, the adjust sleeve 19b rotates and advances in relation to the adjusting spindle 19a, and a retreat position of the piston 17 advances at the brake releasing time, whereby the abrasion of the brake pads 21, 22 is compensated.

Further, in case that the excessive brake fluid pressure is applied onto the piston 17, the adjust sleeve 19b cannot rotate in relation to the adjusting spindle 19a, and the adjusting spindle 19a moves forward against the spring force of the spring 19d together with the adjust sleeve 19b, so that the over-adjustment is prevented.

The parking operation mechanism (PM) includes a parking lever 23 and a cam shaft 25. When the parking lever 23 is operated by a brake wire and the cam shaft 25 rotates, a pair of thrust transmitting assemblies (TA) are driven. The thrust transmitting assembly (TA) includes a rolling roller 29 which rolls between the cam shaft 25 and a roller plug (curved member) 27 provided for the adjusting spindle 19a end, a rolling roller 35 which rolls between the cam shaft 25 and a roller plug (curved member) 33 provided for a housing 31 installed consecutively at the opposite rotor-side end of the caliper 13, and rolling curved surfaces which are formed respectively on the cam shaft 25 and the roller plugs 27 and 33, and on which the rolling rollers 29 and 35 roll.

The roller plug 27, 33 is formed of material which is higher in hardness than material of the housing 31, thrust from the rolling rollers 29 and 35 are caught by the hard roller plugs 27 and 33, and the axial thrust can be surely transmitted to the adjusting spindle 19a and the housing 31 while deformation and abrasion between the rolling rollers 29, 35 and the roller plugs 27, 33 are suppressed as much as possible. Further, even if the size of the rolling roller 29, 35 or the shape of the rolling curved surface in the thrust transmitting assembly (TA) are changed, its change can be met by exchanging only the roller plug 27, 33.

The roller plug 33 is locked by a pin 37 fixed into a bottom of a cylindrical hole 31a in the housing 31 so that the roller plug 33 cannot rotate, and a cylindrical guide (guide member) 39 engaged with this roller plug 33 so that it cannot rotate similarly is unmovably fixed to the housing 31. Namely, regarding the cylindrical guide 39 inserted into the cylindrical hole 31a, its axial movement is obstructed by the roller plug 33 and a snap clip 41, and its rotational movement is obstructed by the roller plug 33.

As shown in FIG. 2, a head portion 20b of the adjusting spindle 19a, in a state where it is energized into a notch guide groove 39a of the cylindrical guide 39 by the spring 19d always in the right direction (in FIG. 1), is supported slidably in an axial direction X-X of the adjusting spindle 19a. On the other hand, the cam shaft 25 is arranged so as to be orthogonal to the axis X-X, fitted into a pair of notch grooves 39b, 39b (refer to FIGS. 2 and 4) formed in the cylindrical guide 39, and supported slidably in the axial direction X-X similarly to the adjusting spindle 19a. Since the cylindrical guide 39 thus supports the adjusting spindle 19a and the cam shaft 25 slidably in the axial direction X-X, the housing 31 requires only the cylindrical hole 31a into which the cylindrical guide 39 can be fitted, and a cam shaft insertion hole 31b (refer to FIG. 2) which will be described later, so that complicated work, and particularly difficult width across flat work are not necessary for the housing.

Next, the detail of components of the parking operation mechanism and an assembly process thereof will be described with reference to FIGS. 2 to 4.

FIG. 2 is an exploded perspective view of the adjusting spindle, the cylindrical guide and the cam shaft in the parking operation mechanism. The adjusting spindle 19a includes a reversible screw portion 20a screwed to the adjust sleeve 19b, and the head portion 20b having a pair of engaging projections 20c which slide into the notch guide grooves 39a in the cylindrical guide 39. Between this head portion 20b and the snap clip 41 provided on one end side of the cylindrical hole 31a formed in the housing 31, the spring 19d is arranged.

The cylindrical guide 39 has a pair of notch grooves 39b for sliding and guiding the cam shaft 25, a peripheral surface 25a of the cam shaft 25 is supported by their notch grooves 39b, and the camshaft 25 is slid and guided in the axial direction X-X of the adjusting spindle 19a by the notch of the notch groove 39b.

As shown in FIG. 3, into the head portion 20b of the adjusting spindle 19a, the roller plug 27 is fitted, a rolling roller 29 is arranged between a rolling curved surface 25b of the cam shaft 25 and a rolling curved surface 27b of the roller plug 27, and the rolling roller 29 and the rolling curved surfaces 25b, 27b constitute a first thrust transmitting assembly (TA). On the other hand, a rolling roller 35 is arranged between a rolling curved surface 25c of the cam shaft 25 and a rolling curved surface 33c of the roller plug 33, and the rolling roller 35 and the rolling curved surfaces 25c, 33c constitute a second thrust transmitting assembly (TA).

Lock grooves 39c, 39c for fitting and locking a pair of lock projections 33a, 33a therein are provided at an end on the roller plug 33 side of the cylindrical guide 39 as shown in FIG. 2. Into the lock grooves 39c, 39c of the cylindrical guide 39, the lock projections 33a, 33a of the roller plug 33 locked so that the roller plug 33 cannot rotate by the pin 37 driven into the bottom of the cylindrical hole 31a are fitted, whereby the cylindrical guide 39 is fixed into the cylindrical hole 31a.

In the assembly process of the parking operation mechanism, firstly, the roller plug 33 is fixed through the pin 37 on the bottom surface of the cylindrical hole 31a formed in the housing 31, the adjusting spindle 19a into which the roller plug 27 has been fitted is inserted into a pair of notch guide grooves 39a, 39a of the cylindrical guide 39, and next the spring 19d is inserted into a cylindrical inner surface 39a of the cylindrical guide 39.

In a state where the cylindrical guide 39 is inserted into the cylindrical hole 31a of the housing 31, the cam shaft 25 is inserted into a pair of notch grooves 39b, 39b of the cylindrical guide 39 through the insertion hole 31b formed in the orthogonal direction to the cylindrical hole 31a formed in the housing 31. When the cam shaft 25 is inserted into the cylindrical hole 31a, a C-shaped regulating block member 26 for regulating the axial movement of the rolling rollers 29 and 35 is forced into the end of the cam shaft 25, and the rolling rollers 29, 35 are housed in the rolling curved surfaces 25b, 25c of the cam shaft 25, whereby the cam shaft assembly 24 is constituted. Further, this insertion hole 31b is elongated a little in the axial direction so that the cam shaft 25 can move in the axial direction X-X.

Next, the structure of the cam shaft assembly 24 and an assembly process thereof will be described with reference to FIG. 5. FIG. 5(a) shows a state before the assembly. A circumferential groove 25f for installing a dust boot 47 is formed on one end side of the cam shaft 25, a width across flat portion 25g for stopping turn of the parking lever 23 is formed outside the circumferential groove 25f, and an external thread portion 25d for locking the parking lever 23 by screwing a nut 43 to the external thread portion 25d is formed outside the width across flat portion 25g.

Further, in the cylindrical peripheral surface 25a of the cam shaft 25, the two recess grooves for housing the rolling rollers 29, 35 therein are formed by cold forging, opposed to each other in the diameter direction. This recess groove extends to the end on the opposite side to the external thread portion 25d for locking the parking lever, and the both recess grooves are connected at this end. The surfaces on which the rolling rollers 29, 35 roll are formed as the rolling curved surfaces 25b, 25c. The rolling curved surface for rolling the rolling rollers 29, 35 thereon is not formed in the shape of a complete recess unlike the conventional rolling curved surface but formed on the recess groove extending to the shaft end portion. Therefore, the formation of the recess groove by cold forging can be readily performed.

Regarding assembly of the cam shaft assembly 24, as shown in FIG. 5(a), firstly the C-shaped regulating block member 26 is forced from the end portion side of the recess groove extending to the shaft end portion of the cam shaft 25 into the recess groove, and the rolling rollers 29 and 35 are housed respectively in the rolling curved surfaces 25b and 25c of the cam shaft 25. The rolling rollers may be greased according to a case. This C-shaped regulating block member 26 functions as a regulating member for restricting the axial movement of the rolling rollers 29 and 35. Hereby, as shown in FIG. 5(b), the cam shaft assembly 24 is assembled so that the rolling rollers 29 and 35 can roll on the rolling curved surfaces 25b and 25c without moving in the axial direction.

At the inserting time of the cam shaft assembly 24, the cylindrical guide 39 is pushed into the inside of the cylindrical hole 31a so that the rolling roller 29 is held between the rolling curved surface 27b of the roller plug 27 and the rolling curved surface 25b of the cam shaft 25, and so that the rolling roller 35 is held between the rolling curved surface 33c of the roller plug 33 and the rolling curved surface 25c of the cam shaft 25. Next, the locking projections 33a, 33a of the roller plug 33 are fitted into the locking grooves 39c, 39c of the cylindrical guide 39, and lastly the snap clip 41 is compressed against the spring 19d and locked into a locking groove 31c (refer to FIGS. 1 and 2) formed in the cylindrical hole 31a of the housing 31.

Hereby, by the cylindrical guide 39 fixed into the cylindrical hole 31a formed in the housing 31, the adjusting spindle 19a and the cam shaft 25 are slid and supported, and the two thrust transmitting assembles (TA) are housed in the housing 31. Thus, the adjusting spindle 19a, the thrust transmitting assembles (TA) and the camshaft 25 can be previously assembled into the housing 31, and they can be handled as a sub-assembly. Further, by detaching the housing 31 from the caliper 13, each part is readily disassembled.

As shown in FIG. 4, the parking lever 23 for driving and rotating the cam shaft 25 around a Y-Y axis which is the axial direction of the cam shaft 25 is fitted to the width across flat portion 25g for stopping turn of the parking lever 23, which is provided at one end of the cam shaft 25. Regarding the parking lever 23, its movement in the Y-Y axis direction is restricted by the nut 43 screwed to the leading-end external thread portion 25d of the cam shaft 25, and its tilt is suppressed by a parking lever guide 45 provided in the insertion hole 31b formed in the housing 31. Further, the parking lever guide 45 restricts the movement of the cam shaft 25 in the Y-Y axis direction. Further, the dust boot 47, of which the inner end side is seated in the circumferential groove 25f of the cam shaft 25, and of which the outer end side is seated in the insertion hole 31b, is attached by a locking pawl 45a of the parking lever guide 45.

The peripheral surface of the nut 43 is capped with a torsion coil spring 49. One end of the torsion coil spring 49 is engaged with the housing 31, and the other end 49a thereof is engaged with the parking lever 23. This torsion coil spring 49 always acts so as to return the cam shaft 25 to the initial position after the operation of the parking lever 23.

The action and a lever ratio (power assist ratio) of the thus assembled parking operation mechanism (PM) will be described with reference to FIG. 6.

A brake wire (not shown) is coupled to a groove 23a provided at one end of the parking lever 23. When the brake wire is pulled up at a point O′ in a direction W by force F, the cam shaft 25 rotates around a point O counterclockwise in FIG. 6. At this time, the cam shaft 25 rotates in a line-contact state with the rolling rollers 29, 35. Therefore, rotational friction resistance which the cam shaft 25 receives is small. When useful length from the point O to a point O′ of action of the force F is taken as L, rotary torque of T=L×F is produced in the cam shaft 25.

In the initial position of the cam shaft before the braking operation, when an angle formed by a line segment g connecting a center of the rolling roller 29 and a contact point of the cam shaft 25 with the rolling curved surface 25b, and the axial line X-X, and an angle formed by a line segment h connecting a center of the rolling roller 35 and a contact point of the cam shaft 25 with the rolling curved surface 25c, and the axial line X-X are taken respectively as θ, and distance between the line segment g and the line segment h is taken as R, the rotary torque L×F is converted into R×f′ (herein, f′ is force generated in the directions of the line segments g, h). Since axial thrust f is expressed by f=f′ cos θ, the lever ratio (power assist ratio) of the parking operation mechanism (PM) is expressed by M=f/F=(L/R)×cos θ.

Then, when the cam shaft 25 rotates from the initial position to the left in FIG. 6, the rolling roller 29, while turning on its axis in the interposed state between the rolling curved surface 25b of the cam shaft 25 and the rolling curved surface 27b of the roller plug 27, rotates around the point O to a brake operating position.

Thus, the moving amount in the axial direction X-X of the rolling rollers 29, 35 is produced by the rotation of the camshaft 25, and the axial thrust can be effectively transmitted to the adjusting spindle 19a and the caliper 13 side with the great lever ratio given to the cam shaft 25 from the parking lever 23.

### Second Exemplary Embodiment

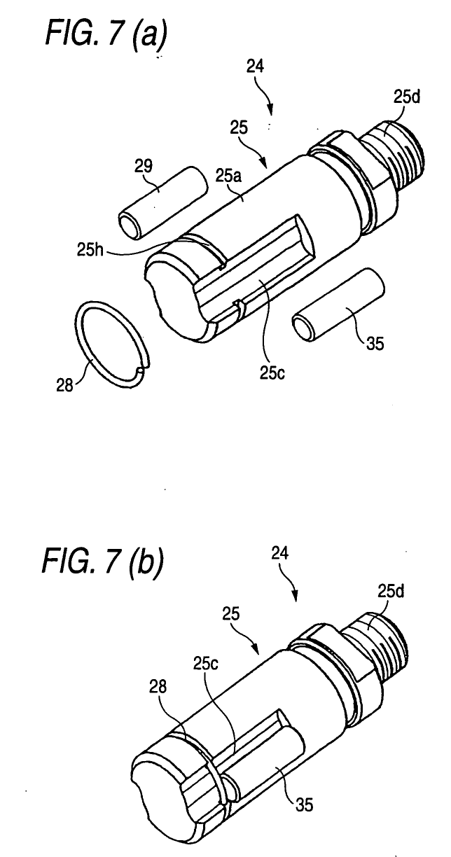

Next, a second exemplary embodiment of the invention will be described with reference to FIG. 7. FIG. 7 is a perspective view showing states before and after incorporation of rolling rollers into a cam shaft in the second exemplary embodiment of the invention, in which FIG. 7(a) shows a state before the incorporation, and FIG. 7(b) shows a state of completion of the incorporation. Components in the second exemplary embodiment similar to those in the first exemplary embodiment are denoted by the same reference numerals, and their detailed description is omitted.

In cylindrical peripheral surface 25a of a cam shaft 25, two recess grooves for housing rolling rollers 29, 35 therein are formed by cold forging, opposed to each other in the diameter direction. This recess groove extends to the end on the opposite side to an external thread portion 25d for locking a parking lever. Surfaces of the recess grooves on which the rolling rollers 29, 35 roll are formed as rolling curved surfaces 25b, 25c. The rolling curved surface for rolling the rolling roller 29, 35 is not formed in the shape of a complete recess unlike the conventional rolling curved surface but formed on the recess groove extending to the shaft end portion. Therefore, also in the second exemplary embodiment, the formation of the recess groove by cold forging can be readily performed.

In a cylindrical peripheral surface 25a of the cam shaft 25, a ring groove 25 h is formed near the shaft end portion on the side where the recess groove is formed. Into this ring groove 25h, a ring member 28 which is cut at a part on its circumference can be fitted. In assembly of a camshaft assembly 24, as shown in FIG. 7(a), firstly the rolling rollers 29 and 35 are housed respectively on the rolling curved surfaces 25b and 25c (refer to FIG. 3 in the first exemplary embodiment) of the cam shaft 25, and the ring member 28 is fitted into the ring groove 25h.

This ring member 28, as shown in FIG. 7(b), comes into contact with one end part of the rolling roller 29, 35, and functions as a regulating member for regulating the axial movement of the rolling rollers 29, 35. Hereby, the cam shaft assembly 24 is assembled so that the rolling rollers 29, 35 can roll on the rolling curved surfaces 25b, 25c without moving in the axial direction.

### Third Exemplary Embodiment

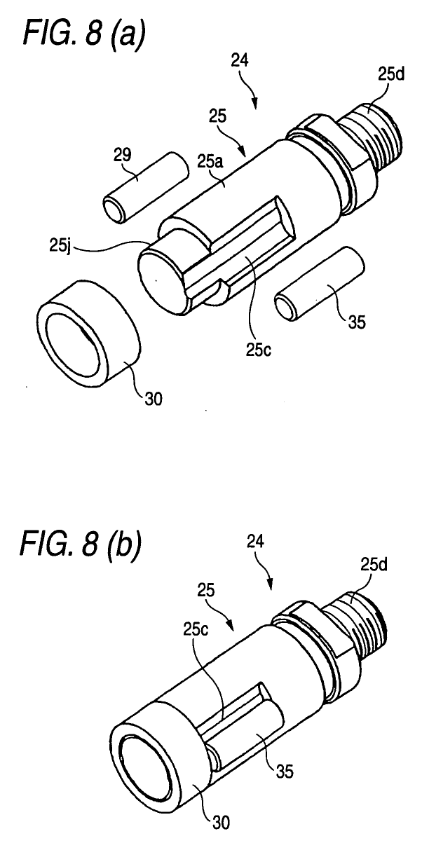

Next, a third exemplary embodiment of the invention will be described with reference to FIG. 8. FIG. 8 is a perspective view showing states before and after incorporation of rolling rollers into a cam shaft in the third exemplary embodiment of the invention, in which FIG. 8(a) shows a state before the incorporation, and FIG. 8(b) shows a state of completion of the incorporation. Components in the third exemplary embodiment similar to those in the first exemplary embodiment are denoted by the same reference numerals, and their detailed description is omitted.

In a cylindrical peripheral surface 25a of a cam shaft 25, two recess grooves for housing rolling rollers 29, 35 therein are formed by cold forging, opposed to each other in the diameter direction. This recess groove extends to the end on the opposite side to an external thread portion 25d for locking a parking lever. Surfaces of the recess grooves on which the rolling rollers 29, 35 roll are formed as rolling curved surfaces 25b, 25c. The rolling curved surface for rolling the rolling roller 29, 35 is not formed in the shape of a complete recess unlike the conventional rolling curved surface but formed on the recess groove extending to the shaft end portion. Therefore, also in the third exemplary embodiment, the formation of the recess groove by cold forging can be readily performed.

At the shaft end on the side where the recess groove of the cam shaft 25 is formed, a diameter-reduced step portion 25j is formed by cold forging simultaneously with the formation of the recess groove. Therefore, the manufacturing process of the cam shaft is simplified, which is suitable to mass production. Into this diameter-reduced step portion 25j, a sleeve 30 can be forced. In assembly of a cam shaft assembly 24, as shown in FIG. 8(a), firstly the sleeve 30 is forced into the diameter-reduced step portion 25j of the cam shaft 25, and next the rolling rollers 29 and 35 are housed respectively on the rolling curved surface 25b (refer to FIG. 3 in the first exemplary embodiment) and 25c.

This sleeve 30, as shown in FIG. 8(b), comes into contact with one end part of the rolling roller 29, 35, and functions as a regulating member for regulating the axial movement of the rolling rollers 29, 35. Hereby, the cam shaft assembly 24 is assembled so that the rolling rollers 29, 35 can roll on the rolling curved surfaces 25b, 25c without moving in the axial direction.

Further, it is also clear that the rolling curved surface 25b, 25c need not be extended to the end portion by reducing the diameter of this diameter-reduced step portion 25j.

Further, in the first exemplary embodiment and the third exemplary embodiment, though the C-shaped regulating block member 26 and the sleeve 30 are forced into the cam shaft 25, they may be fixed by other fixing methods than the forcing method.

### Fourth Exemplary Embodiment

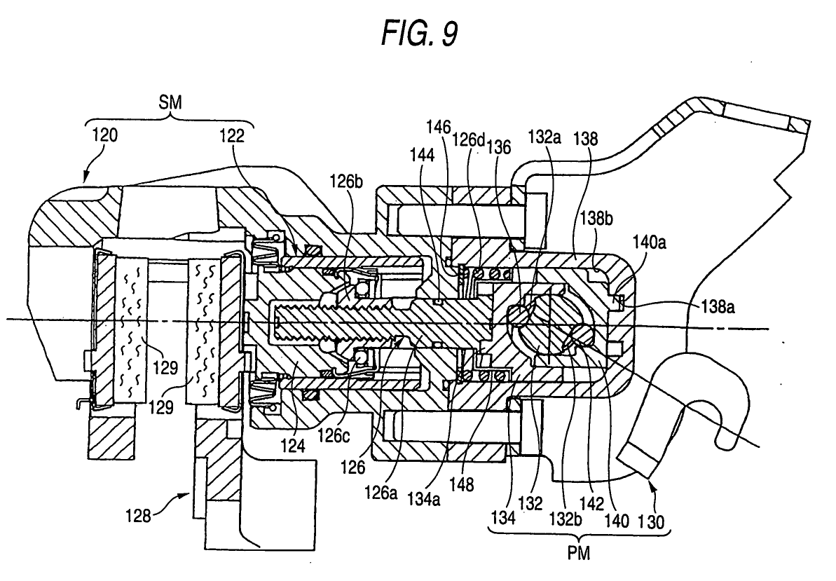

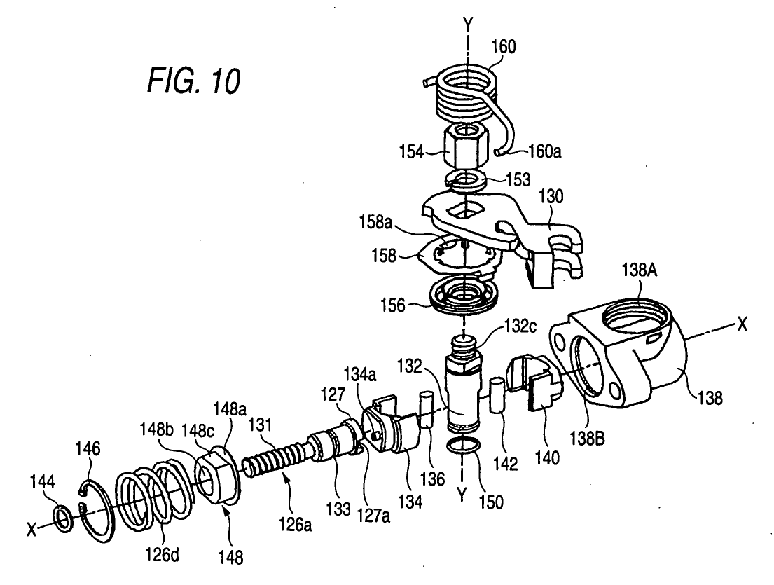

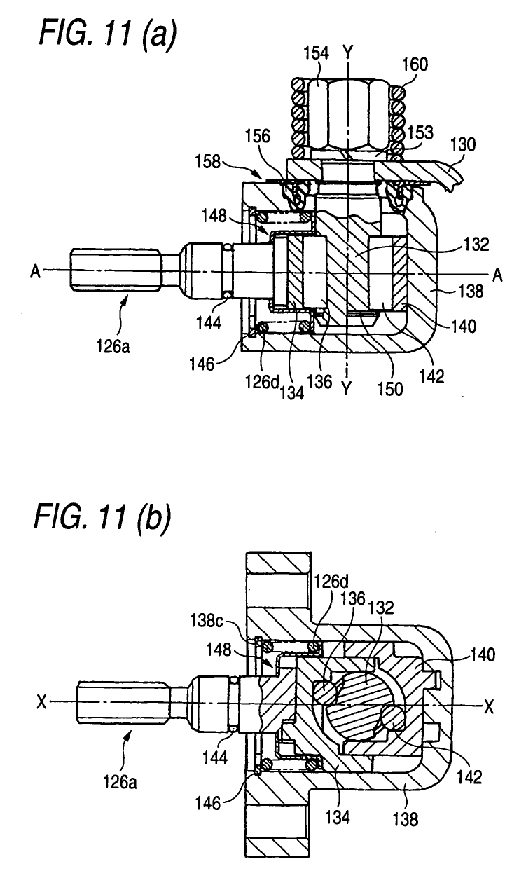

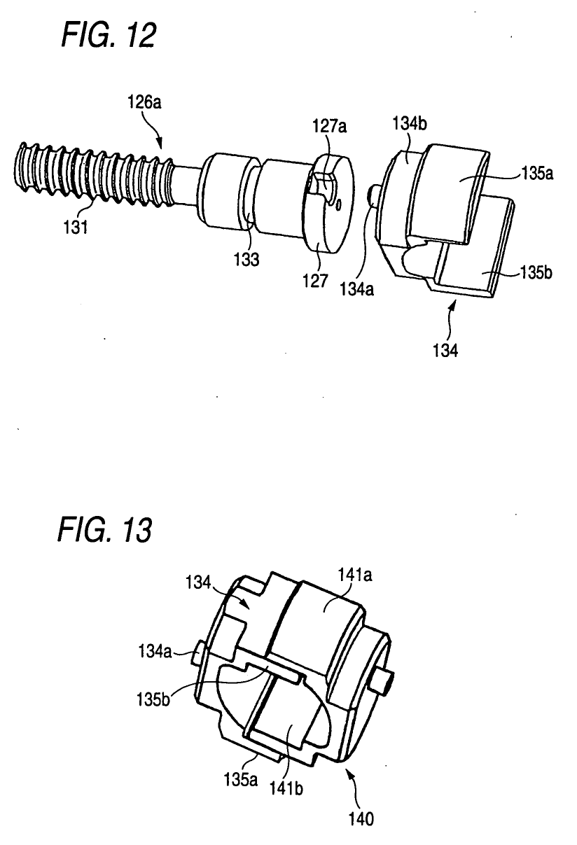

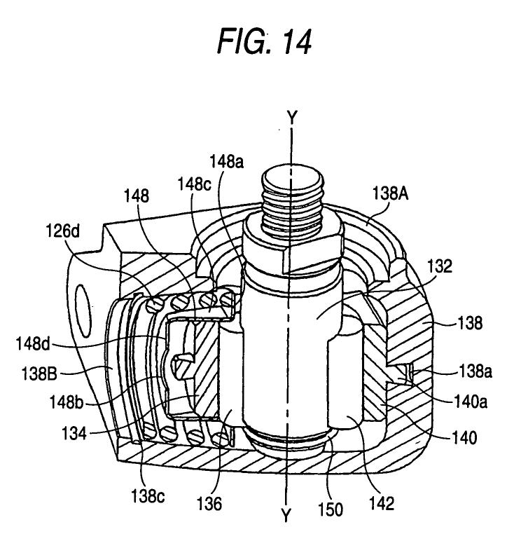

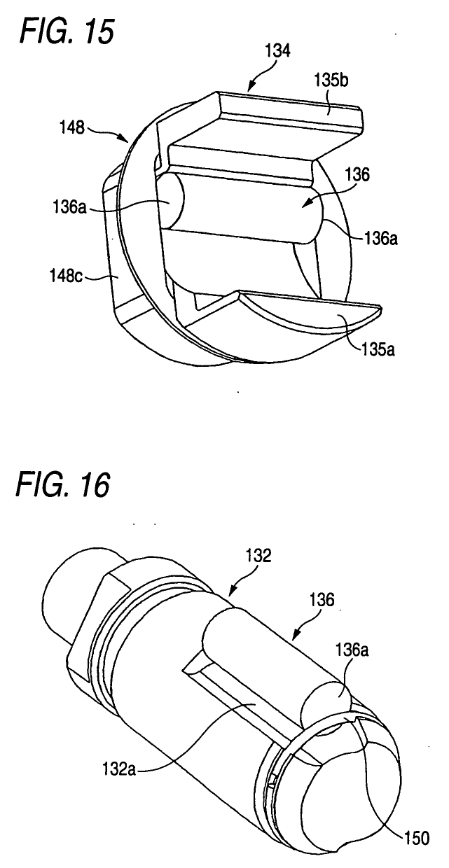

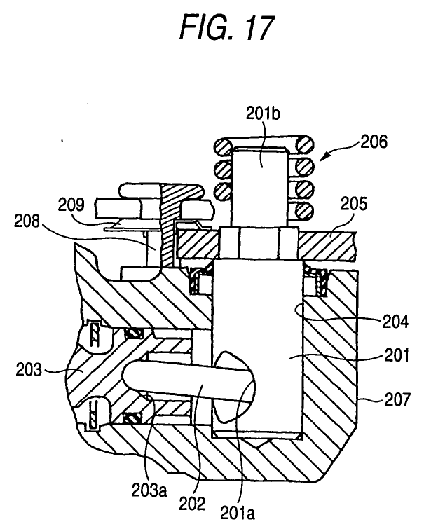

FIG. 9 is a sectional view showing the whole of a main portion of a disc brake operating system including parking operation mechanism in a fourth exemplary embodiment of the invention, FIG. 10 is an exploded perspective of the parking operation mechanism, FIG. 11(a) is a sectional view of a built-in rotation-linear converting part of the parking operation mechanism, FIG. 11(b) is a sectional view taken along a line A-A in FIG. 11(a), FIG. 12 is a perspective view of an adjusting spindle and a first roller plug, FIG. 13 is a perspective view of the first roller plug and a second roller plug which are built in each other, FIG. 14 is a partially broken and perspective view of the rotation-linear converting part, showing the details of a holder, FIG. 15 is a perspective view showing a holding state of a first rolling roller by the holder, and FIG. 16 is a perspective view showing a holding state of both rolling rollers by a ring provided for a cam shaft.

As shown in FIG. 9, a disc brake operating system of the fourth exemplary embodiment includes a service brake mechanism (SM) for fluid operation which consists of a caliper 120 and a piston assembly 122, and a parking operation mechanism (PM). The piston assembly 122 includes a piston 124 which receives fluid pressure at the applying time of service brake and slides in the caliper 120, and an adjuster mechanism 126 for compensating abrasion of a brake pad and preventing over-adjustment. This caliper 120 is supported slidably in relation to a fixed support 28.

As the adjuster mechanism 126, the known reversible screw type is used. This reversible screw type adjuster consists of an adjusting spindle 126a having a reversible screw, an adjust sleeve 126b which is screwed to this spindle 126a, a bearing 126c which supports rotational movement of the adjust sleeve 126b, and a spring 126d. When the abrasion of brake pads 129, 129 becomes more than the predetermined value, the adjust sleeve 126b rotates and advances in relation to the adjusting spindle 126a, and a retreat position of the piston 124 advances at the brake releasing time, whereby the abrasion of the brake pads 129, 129 is compensated.

Further, in case that the excessive brake fluid pressure is applied onto the piston 124, since the adjusting spindle 126a moves forward against the spring force of the spring 126d together with the adjust sleeve 126b, the adjust sleeve 126b cannot rotate in relation to the adjusting spindle 126a, so that the over-adjustment is prevented.

The parking operation mechanism (PM) includes a parking lever 130, a cam shaft 132 and a rotation-linear converting part. When the parking lever 130 is operated by a brake wire and the cam shaft 132 arranged so as to be orthogonal to an axial line X-X of the adjusting spindle 126a rotates, the rotation-linear converting part rotates. This rotation-linear converting part includes a first roller plug 134 which engages irregularly with the adjusting spindle 126a, a first rolling roller 136 which rolls between the cam shaft 132 and the first roller plug 134 while turning on its axis, and is held in a cam groove 132a, a second roller plug 140 which engages irregularly with a housing 138 installed consecutively at the opposite rotor-side end of the caliper 120 (the caliper 120 may include the housing 138), and a second rolling roller 142 which rolls between the cam shaft 132 and the second roller plug 140 while turning on its axis, and is held in a cam groove 132b. The first rolling roller 136 and the second rolling roller 142 are arranged point-symmetrically about a center of the cam shaft 132.

On the peripheral surfaces of the cam grooves 132a, 132b in the cam shaft 132 in which the first and second rolling rollers 136, 142 roll, and on the inner surfaces of the first and second roller plugs 134, 140, rolling curved surfaces are formed in order to give axial thrust to the first and second rolling rollers 136, 142 at the rotating time of the cam shaft 132.

The first and second roller plugs 134, 140 are formed respectively of material which is higher in hardness than material of the housing 138, thrust from the first and second rolling rollers 136 and 140 are caught by the hard roller plugs 134 and 140, and the axial thrust can be surely transmitted to the adjusting spindle 126a and the housing 138 while deformation and abrasion between the rolling rollers 136, 142 and the roller plugs 134, 140 are suppressed as much as possible. Further, even if the size of the first and second rolling rollers 136, 142 in the rotation-linear converting part or the shape of the rolling curved surface are changed, its change can be met by exchanging only the first and second roller plugs 134, 140.

The second roller plug 140 includes an engaging projection 140a which extends to the housing 138 side, and the engaging projection 140a engages with an engaging recess portion 138a formed in the housing 138. The first roller plug 134 has the same shape as the shape of the second roller 140. As shown in FIG. 12, the first roller plug 134 also includes an engaging projection 134a, which engages with an engaging recess portion 127a formed in a head portion 127 of the adjusting spindle 126a. Thus, by forming the first roller plug 134 and the second roller plug 140 in the same shapes, common use of parts is possible.

The engaging position of the first roller plug 134 with the adjusting spindle 126a, and the engaging position of the second roller plug 140 with the housing 138 are not co-axial in relation to an axial line X-X of the adjusting spindle 126a. Therefore, the rotational movement around the axial line X-X of the second roller plug 140 in relation to the housing 138 is obstructed. Further, since the engaging projections 134a and 140a, when the first roller plug 134 and the second roller plug 140 are formed by forging, can be formed simultaneously, their manufacturing process is also simple.

Next, the structure and incorporation of the first and second roller plugs 134 and 140 will be described with reference to FIGS. 12 and 13. Since the first and second roller plugs 134 and 140 have the same shapes, the structure of only the first roller plug 134 shown in FIG. 12 will be described. The first roller plug 134 consists of a main body 134b and a pair of sliding arm portions 135a and 135b which are opposed to each other in the diameter direction and rectangular. On the main body 134b, the engaging projection 134a is formed. The inner surfaces of the sliding arm portions 135a and 135b are finished as flat surfaces, and the outer surface of the sliding arm portion 135a is formed into a partially cylindrical surface which is slidingly contactable with a cylindrical inner surface 138b of the housing 138.

Regarding the incorporation of the first and second roller plugs 134 and 140, as shown in FIG. 13, the sliding arm portions 135a, 135b of the first roller plug 134, and sliding arm portions 141a, 141b of the second roller plug 140 are fitted alternately into each other, and the cam shaft 132 is slidably brought into contact with and supported by the inner surface of the inward sliding arm portion 135b of the first roller plug 134 and the inner surface of the inward sliding arm portion 141b of the second roller plug 140. The sliding arm portion 135b and the sliding arm portion 141a are fitted into each other slidably in the axial direction X-X of the adjusting spindle 126a. Similarly, the sliding arm portion 135a and the sliding arm portion 141b are fitted into each other. Therefore, for the cam shaft 132, only the rotational movement around the axis Y-Y of the cam shaft 132 (refer to FIG. 11(a)) which is orthogonal to the axis X-X of the adjusting spindle 126a, and the movement in the axial direction X-X of the adjusting spindle 126a are permitted. Therefore, an insertion hole 138A (refer to FIG. 10) of the housing 138 is such a big hole that the cam shaft 132 can move in the axial direction X-X.

As described before, the rotational movement around the axis X-X in relation to the housing 138, of the second roller plug 140 is obstructed, and the first roller plug 134 is fitted into the second roller plug 140 at their sliding arm portions and also fitted onto the peripheral surface of the cam shaft 132 so as to come into linear contact with the peripheral surface of the cam shaft 132 in the axial direction. Therefore, since the first roller plug 134 cannot rotate around the axis X-X, and the engaging position of the first roller plug 134 with the adjusting spindle 126a is not co-axial in relation to the axis X-X of the adjusting spindle 126a, the rotational movement of the adjusting spindle 126a around the axis X-X is obstructed.

Next, the details of components of the parking operation mechanism and an assembly process thereof will be described with reference to FIGS. 10 to 16.

FIG. 10 is an exploded perspective view showing a state before assembly of the parking operation mechanism mainly consisting of the adjusting spindle 126a, the cam shaft 132 having the parking lever, the housing 138 and the rotation-linear converting part. The adjusting spindle 126a consists of a reversible screw portion 131 which screws to the adjust sleeve 126b, and a head portion 127 provided with an engaging recess portion 127a which engages with the engaging projection 134a of the first roller plug 134. In the middle spindle portion connecting this head portion 127 and the reversible screw portion 131, a ring-shaped seal groove 133 is formed as shown in FIG. 12. Into this seal groove 133, a seal ring 144 (refer to FIGS. 9 and 11(b)) is fitted.

Into a ring groove 138c (refer to FIG. 11(b)) formed at the end on the adjusting spindle 126a side of the housing 138, a snap clip 146 is locked. Between this snap clip 146 and the first roller plug 134, as shown in FIG. 14, the spring 126d is provided through the flange portion 148a of the holder 148. Therefore, when the spring 126d is set, the adjusting spindle 126a is energized through the holder always in the right direction (in FIG. 9). A through hole 148b is formed in the holder 148. In FIG. 10, when the holder 148 is incorporated, the adjusting spindle 126a is fitted into the through hole 148b of the holder 148 from the right direction, and the holder 148 goes beyond the head portion 127 of the adjusting spindle 126 and a part of the first roller plug 134, and is set so as to regulate the axial positions of the both ends of the first rolling roller 136 and hold the first rolling roller 136 as shown in FIG. 15.

As shown in FIGS. 14 and 15, in the cylindrical peripheral surface of the holder 148, portions opposed to each other in the diameter direction are formed into partially flat surfaces 148c. This pair of flat surfaces 148c supports the both ends of the first rolling roller 136 so as to hold them from the upside and the downside, and the flat surfaces 148c are constructed so that they can always hold the first rolling roller 136 even if the first rolling roller 136 rolls. Further, a roller support ring 150 is provided on the leading end side of the cam shaft 132. When the cam shaft 132 is inserted into the insertion hole 138A of the housing 138, as shown in FIGS. 14 and 16, the roller support ring 150 supports the first and second rolling rollers 136 and 142 which are partially housed in the cam grooves 132a, 132b so as to prevent them from falling down from the cam shaft 132. Further, the roller support ring 150 supports the cam shaft 136 so as to prevent the cam shaft 136 from falling out upward (to the parking lever 130 side) in a state where the first rolling roller 136 remains.

As shown in FIG. 11(a), into one end of the cam shaft 132, the parking lever 130 for driving and rotating the cam shaft 132 around the axis Y-Y of the cam shaft 132 is fitted. The movement in the axial direction Y-Y of this parking lever 130 is restricted by a nut 154 screwed through a washer 153 to a leading end 132c (refer to FIG. 10) of the cam shaft 132. Further, as shown in FIG. 10, a dust boot 156 provided between the cam shaft 132 and the insertion hole 138A is held by a locking pawl 158a of a boot holder 158 attached to the insertion hole 138A, and prevents dust or water from intruding into the rotation-linear converting part from the outside.

The peripheral surface of the nut 154 is capped with a torsion coil spring 160. One end of the torsion coil spring 160 is engaged with the housing 138, and the other end 160a (refer to FIG. 10) is engaged with the parking lever 130. This torsion coil spring 160 always acts so as to return the cam shaft 132 to the initial position after the operation of the parking lever 130.

In the assembly procedure of the parking operation mechanism, firstly, at the bottom of the cylindrical hole 138B formed in the housing 138, the engaging projection 140a of the second roller plug 140 is engaged with the engaging recess portion 138a provided in the housing 138, and the first and second rolling rollers 136, 142 partially housed in the cam grooves 132a, 132b of the cam shaft 132 are supported by the roller support ring 150 while their axial positions are regulated. Next, in a state where the dust boot 156, the boot holder 158, the parking lever 130, the washer 153, the nut 154, and the torsion coil spring 160 have been attached to the upper end of the cam shaft 132, the cam shaft 132 is inserted into the insertion hole 138A of the housing 138. The downward movement of the cam shaft 132, as shown in FIG. 11(a) is obstructed by the contact of the boot holder 158 with the housing 138. After the cam shaft 132 has been inserted, the torsion coil spring 160 is locked to the housing 138 and the parking lever 130.

On the other hand, into the engaging recess portion 127a formed in the head portion 127 of the adjusting spindle 126a, the engaging projection 134a of the first roller plug 134 is fitted thereby to integrate the adjusting spindle 126a with the first roller plug 134, the seal ring 144 is fitted into the seal groove 133 formed in the middle spindle portion of the adjusting spindle 126a, and the holder 148 and the spring 126d are fitted toward the first roller plug 134 side from the reversible screw portion 129 side of the adjusting spindle 126a in order, whereby an assembly is formed. This assembly is inserted into the cylindrical hole 138B of the housing 138.

Lastly, as shown in FIG. 11(b), the snap clip 146 is locked in the ring groove 138c of the housing 138. Hereby, the first roller plug 134 is pressed to the right through the holder 148 by the spring power of the spring 126d, and the cam shaft 132 is held between the first roller plug 134 and the second roller plug 140 through the first and second rolling rollers 136 and 142. Hereby, the rotation-linear converting part is housed in the housing 138, the adjusting spindle 126a can move in the axial direction X-X, and the cam shaft 132 is supported so that it can rotate around the axis Y-Y and can move in the axial direction X-X.

The holder 148 is formed in section in the shape of a hat, and includes a flange portion 148a which receives one end side of the spring 126d, flat portions 148c for holding the first rolling roller 136 between them, and a locking portion 148d which engages with the head portion 127 of the adjusting spindle 126a as shown in FIG. 14. In a state where the holder 148 is set in the incorporated position, the upper and lower flat portions 148c hold the both end surfaces 136a of the first rolling roller 136, regulating the positions of the both end surfaces 136a in the axial direction. Therefore, the movement in the axial direction Y-Y of the cam shaft 132 is suppressed by the holder 148 through the first rolling roller 136, so that there is no fear that the cam shaft 132 comes off upward from the insertion hole 138A. Thus, it is not necessary to prepare the special part for preventing coming-off of the cam shaft 132, and it is possible to prevent the coming-off of the cam shaft 132 in the usual parts assembly process.

Next, the action of the rotation-linear converting part will be described. When the cam shaft 132 is rotated to the left in FIG. 9 by the parking lever 130 from the initial position where the first and second rolling rollers 136, 142 are held respectively between the cam shaft 132 and the first and second roller plugs 134, 140, the first rolling roller 136 rotates to the predetermined position while turning on its axis between the cam groove 132a of the cam shaft 132 and the rolling curved surface of the first roller plug 134. Similarly, the second rolling roller 142 also rotates to the predetermined position while turning on its axis between the cam groove 132b of the cam shaft 132 and the rolling curved surface of the second roller plug 140.

When the first and second rolling rollers 136, 142 move to the predetermined position according to the rotating amount of the cam shaft 132, the first roller plug 134 moves to the left and gives thrust to the adjusting spindle 126a, and simultaneously the second roller plug 140 moves to the right and gives thrust to the housing 138.

In the parking brake operation, by pulling a brake wire (not shown) coupled to one end of the parking lever 130, the cam shaft 132 rotates around the Y-Y axis, the axial thrust in the axial direction X-X is applied to the adjusting spindle 126a through the first rolling roller 136 and the first roller plug 134, and simultaneously the axial thrust in the axial direction X-X can be applied to the housing 138 through the second rolling roller 142 and the second roller plug 140. The axial thrust applied to the adjusting spindle 126a is transmitted to one of the brake pads 129 through the adjust sleeve 126b and the piston 124, and the axial thrust applied to the housing 138 is transmitted to the other brake pad 129 by moving the caliper 101 slidably supported by the fixed support 128 to the right in FIG. 9, whereby the braking force can be applied to the rotor.

Though the specific exemplary embodiments of the invention have been described above with reference to the drawings, the embodiments of the present invention are not limited to these specific exemplary embodiments. For example, though the exemplary embodiments are applied to a floating caliper type disc brake, in case that the invention is applied to a fixed caliper type disc brake, it is also possible to provide the thrust transmitting assembly only between the cam shaft and the adjusting spindle. Further, since the roller plug is formed of the hard material, it is formed separately from the adjusting spindle and the housing. However, the roller plug is not always required, but the rolling curved surfaces may be formed directly on the adjusting spindle and the housing.

In addition, it has been described above that the first roller plug 134 and the second roller plug 140 are formed in the same shape, however, they may be formed in the different shape.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A disc brake operating system comprising:
a piston including an adjuster mechanism;
a caliper that slidably supports the piston; and
a parking operation mechanism provided on one end side of the caliper,
wherein the parking operation mechanism includes:
an adjusting spindle of the adjuster mechanism;
a cam shaft located orthogonally to the adjusting spindle and having a parking lever at one end of the cam shaft; and
a thrust transmitting assembly that is arranged between the cam shaft and the adjusting spindle and generates an axial thrust to the adjusting spindle by a rotational movement of the cam shaft,
the thrust transmitting assembly includes:
a rolling roller that rolls between the cam shaft and the adjusting spindle while turning on its axis; and
rolling curved surfaces provided on the cam shaft and on a side of the adjusting spindle, wherein the rolling curved surfaces comes into contact with the rolling roller,
the rolling curved surface on the cam shaft is formed on a recess groove extending to a side of the cam shaft opposite to the parking lever, and
the rolling roller is housed in the rolling curved surface and a axial movement of the rolling roller is restricted by a regulating member.

2. The disc brake operating system according to claim 1, wherein a second thrust transmitting assembly is arranged between an opposite rotor side of the cam shaft and the caliper.

3. The disc brake operating system according to claim 1, wherein the regulating member comprises a regulating block member fixed into the recess groove from an end side of the cam shaft.

4. The disc brake operating system according to claim 3, wherein the regulating block member comprises a C-shaped regulating block member fixed into the recess groove from the end side of the cam shaft.

5. The disc brake operating system according to claim 1, wherein the regulating member comprises a ring member inserted into a ring groove formed on a cylindrical outer surface of the cam shaft.

6. The disc brake operating system according to claim 1, wherein the regulating member comprises a sleeve fixed to a diameter-reduced step portion formed at an end of the cam shaft, which is located on the opposite side to the parking lever.

7. The disc brake operating system according to claims 1, wherein a cylindrical hole facing in an axial direction of the adjusting spindle, and an insertion hole facing in an orthogonal direction to the cylindrical hole are formed at the opposite rotor-side end of the caliper, and
a guide member which slides and supports the cam shaft inserted from the insertion hole is fixed into the cylindrical hole.

8. The disc brake operating system according to claim 7, wherein the cam shaft is slid and supported by a pair of notch grooves formed in a cylindrical portion of the guide member.

9. The disc brake operating system according to claim 1, wherein a parking lever guide for suppressing a tilt of the parking lever is provided for the caliper; and
a dust boot is attached between the parking lever guide and the cam shaft.

10. The disc brake operating system according to claim 1, wherein the caliper has a housing installed consecutively at its opposite rotor-side end; and
the adjusting spindle, the thrust transmitting assembly and the cam shaft are integrally assembled in the housing.

11. A disc brake operating system comprising:
a piston including an adjuster mechanism;
a caliper that slidably supports the piston; and
a parking operation mechanism provided on one end side of the caliper,
wherein the parking operation mechanism includes:
an adjusting spindle of the adjuster mechanism;
a cam shaft located orthogonally to the adjusting spindle and having a parking lever at one end of the cam shaft; and
a rotation-linear converting part that is arranged between the cam shaft and the adjusting spindle and generates an axial thrust to the adjusting spindle by rotation of the cam shaft,
the rotation-linear converting part includes:
a first roller plug that comes into contact with and engages with the adjusting spindle;
a first rolling roller that rolls between the cam shaft and the first roller plug while turning on its axis, and is held in a cam groove of the cam shaft;
a second roller plug that comes into contact with and engages with a caliper housing; and
a second rolling roller that rolls between the cam shaft and the second roller plug while turning on its axis, and is held in a cam groove of the cam shaft,
the adjusting spindle presses the first roller plug through the first rolling roller to the cam shaft side by spring power of a spring that acts on a holder engaging with the adjusting spindle, and
the holder regulates the axial positions of both end portions of the first rolling roller on its end inner surfaces.

12. The disc brake operating system according to claim 11, wherein the holder is formed in section nearly in a shape of a hat, and includes a flange portion that holds one end of the spring at one end thereof, and a locking portion engaged with the adjusting spindle at the other end thereof.

13. The disc brake operating system according to claim 11, wherein the first and second rolling rollers are partially housed in the cam grooves formed on the cam shaft, and lower end surfaces of the both rolling rollers are regulated in their axial positions by a roller support ring provided on the cam shaft.
